(19) United States
(12) Patent Application Publication
(10) Pub. No.: US 2007/0232357 A1
(43) Pub. Date: Oct. 4, 2007

(54) Electronic apparatus and communication control method

(76) Inventor: Nobuaki Takasu, Akishima-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/715,053

(22) Filed: Mar. 7, 2007

(30) Foreign Application Priority Data
Mar. 29, 2006 (JP) 2006-090598

(51) Int. Cl. H04B 1/38

(52) U.S. Cl. 455/558

(57) ABSTRACT

According to one embodiment, an electronic apparatus includes a device detection unit which detects an external device which is located within a wireless communication area that is covered by the electronic apparatus, a distance calculation unit which calculates a distance between the electronic apparatus and the detected external device on the basis of a radio-wave intensity of a wireless signal which is transmitted from the detected external device, and a connection control unit which establishes wireless connection between the detected external device and the electronic apparatus if the distance calculated by the distance calculation unit is within a predetermined reference distance.

### CROSS-REFERENCE TO RELATED APPLICATIONS

This application is based upon and claims the benefit of priority from Japanese Patent Application No. 2006-090598, filed Mar. 29, 2006, the entire contents of which are incorporated herein by reference.

### BACKGROUND

1. Field

One embodiment of the invention relates to an electronic apparatus which can execute wireless communication, and a communication control method for use in the electronic apparatus.

2. Description of the Related Art

In recent years, various types of electronic apparatuses, such as a personal computer, a video recorder and a TV set, have been developed. These electronic apparatuses have wired interfaces for executing communication with various external devices which function as peripheral devices.

Recently, a wireless interface has begun to be used in place of the wired interface. By using the wireless interface, the communication between the electronic apparatus and the external device can easily be executed with use of a wireless signal, without connecting the external device to the electronic apparatus over a cable.

Jpn. Pat. Appln. KOKAI Publication No. 2004-274532 discloses a computer having a function of prompting a user to select a device, which is an object of wireless connection, from a list of a plurality of devices which are discovered within a wireless communication area.

In this computer, however, the user cannot use a target device unless he/she executes an operation of selecting a device from the list of discovered (detected) devices, and an operation of instructing the start of a connection process for connection to the selected device.

Normally, a short-range wireless communication system, such as Bluetooth™, is provided with an automatic connection function for automatically wirelessly connecting an external device, which is detected by a computer functioning as a host device, to the computer. This automatic connection function enables the user to use the external device, without requiring the user to execute, e.g. a device selection operation.

The automatic connection function, however, establishes wireless connection between all detected external devices and the computer, regardless of the distance between the computer and external devices. The range of the wireless communication area of the short-distance wireless communication system is, normally, 10 m or more. It is thus possible that an external device, which is present at a far place at a distance of about 10 m from the computer and is not necessary for the user, may automatically be wirelessly connected to the computer.

For example, even in the case where an external device, such as a mouse or a keyboard, which should be used near the computer, is present at a far place at a distance of about 10 m from the computer, the external device, if in the power-on state, is wirelessly connected to the computer. In this case, the control of the computer is abruptly shifted to the external device that is present at a far place at a distance of about 10 m from the computer.

It is thus necessary to realize a novel function for automatically establishing wireless connection to an external device which is to be used with high possibility.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing a general appearance of a computer according to an embodiment of the invention;

FIG. 2 is an exemplary view for explaining a communication control function of the computer shown in FIG. 1;

FIG. 3 is an exemplary block diagram showing the system configuration of the computer shown in FIG. 1;

FIG. 4 is an exemplary block diagram showing the functional structure of a communication control program which is used by the computer shown in FIG. 1;

FIG. 5 is an exemplary graph showing an example of radio-wave intensity attenuation characteristics in association with a wireless communication device which is provided in the computer shown in FIG. 1;

FIG. 6 is an exemplary flow chart illustrating a first example of the procedure of a device connection process which is executed by the computer shown in FIG. 1;

FIG. 7 shows an example of a pop-up message which is displayed by the computer shown in FIG. 1;

FIG. 8 is an exemplary flow chart illustrating a second example of the procedure of the device connection process which is executed by the computer shown in FIG. 1;

FIG. 9 is an exemplary flow chart illustrating a first example of the procedure of a device disconnection process which is executed by the computer shown in FIG. 1;

FIG. 10 is an exemplary flow chart illustrating a second example of the procedure of the device disconnection process which is executed by the computer shown in FIG. 1; and

FIG. 11 shows an example of a distance setup screen which is displayed by the computer shown in FIG. 1.

### DETAILED DESCRIPTION

Various embodiments according to the invention will be described hereinafter with reference to the accompanying drawings. In general, according to one embodiment of the invention, an electronic apparatus includes a device detection unit which detects an external device which is located within a wireless communication area that is covered by the electronic apparatus, a distance calculation unit which calculates a distance between the electronic apparatus and the detected external device on the basis of a radio-wave intensity of a wireless signal which is transmitted from the detected external device, and a connection control unit which establishes wireless connection between the detected external device and the electronic apparatus if the distance calculated by the distance calculation unit is within a predetermined reference distance.

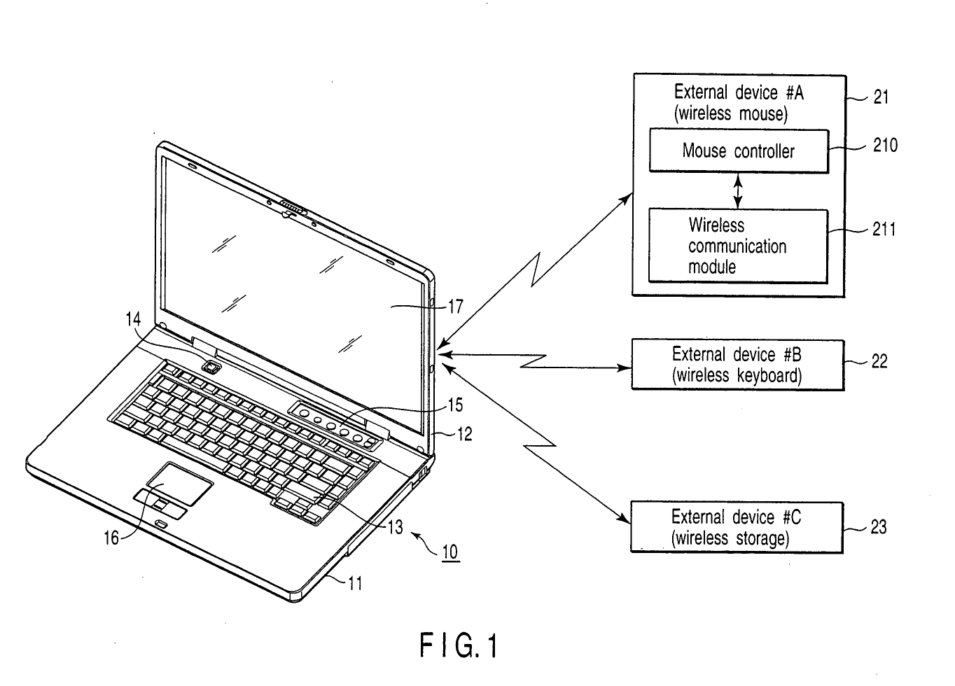

FIG. 1 is a perspective view showing an external appearance of an electronic apparatus according to the embodiment of the invention. The electronic apparatus is realized, for example, as a notebook-type portable personal computer 10.

The computer 10 includes a wireless communication unit which supports a short-distance wireless communication system such as Bluetooth™, or Wireless USB. The computer 10 can execute wireless communication with various external devices, 21, 22, 23, . . . Each of the external devices 21, 22 and 23 has a wireless communication function which supports a short-distance wireless communication system such as Bluetooth™, or Wireless USB. Each of the external devices 21, 22 and 23 functions as a peripheral device which can be controlled by the computer 10.

The external device (#A) 21 is an external input device which inputs information to the computer 10 by a wireless signal, and is realized, for example, as a wireless mouse device. The external device (#A) 21 includes a mouse controller 210 which is a core unit for executing a mouse function, and a wireless communication module 211 for executing wireless communication according to the Bluetooth™ standard or Wireless USB standard.

The external device (#B) 22 is an external input device which inputs information to the computer 10 by a wireless signal, and is realized, for example, as a wireless keyboard device. The external device (#B) 22 includes a keyboard unit and a wireless communication module for executing wireless communication according to the Bluetooth™ standard or Wireless USB standard.

The external device (#C) 23 is an external storage device for storing data, which is transmitted from the computer 10 by a wireless signal. The external device (#C) 23 includes a storage unit such as a flash memory or a hard disk drive, and a wireless communication module for executing wireless communication according to the Bluetooth™ standard or Wireless USB standard.

The computer 10 comprises a computer main body 11 and a display unit 12. A display device that is composed of a TFT-LCD (Thin Film Transistor Liquid Crystal Display) 17 is built in the display unit 12. The display screen of the LCD 17 is positioned at an approximately central part of the display unit 12. The display unit 12 is attached to the computer main body 11 such that the display unit 12 is freely rotatable between an open position and a closed position. The computer main body 11 has a thin box-shaped casing. A keyboard 13, a power button 14 for powering on/off the computer 10, an input operation panel 15 and a touch pad 16 are disposed on the top surface of the computer main body 11.

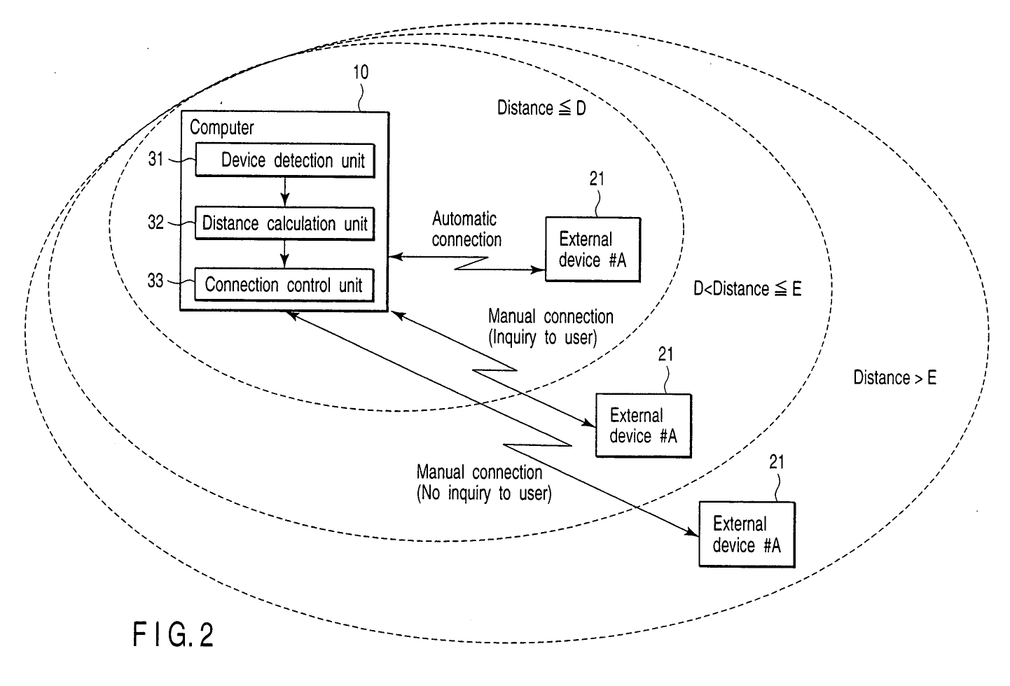

Next, referring to FIG. 2, the communication control function of the computer 10 is explained.

The computer 10 includes a device detection unit 31, a distance calculation unit 32 and a connection control unit 33 as functional modules which control the wireless communication unit in the computer 10.

The device detection unit 31 controls the wireless communication unit which is provided in the computer 10 and executes a device detection process for detecting an external device which is located within a wireless communication area (also referred to as “radio range”) which is covered by the wireless communication unit, that is, within a wireless communication area covered by the computer 10. The external device, which is detected by the device detection process, is an external device which is located within a range of, e.g. about 15 m in radius from the computer 10. For example, in the case where the wireless communication unit is a device supporting the Wireless USB standard, the device detection unit 31 detects an external device, which is located within the wireless communication area, on the basis of device notice information which is sent from the external device by a wireless signal and is received by the wireless communication unit. The device notice information includes, e.g. device identification information (device ID, device address, etc.) for identifying the external device. In the case where the wireless communication unit is a device supporting the Bluetooth™ standard, the device detection unit 31 detects an external device, which is located within the wireless communication area, on the basis of response information which is received by the wireless communication unit, the response information being transmitted from external devices in response to inquiries from the wireless communication unit. The response information, too, includes, e.g. device identification information (device ID, device address, etc.) for identifying the external device.

The distance calculation unit 32 calculates a distance between the computer 10 and the detected external device on the basis of the radio-wave intensity of a wireless signal which is sent from the external device that is detected by the device detection process. In the distance calculation process, the distance calculation unit 32 acquires data (radio-wave intensity data), which is indicative of the radio-wave intensity of the wireless signal sent from the detected external device, from the wireless communication unit in the computer 1, and estimates the distance between the computer 10 and external device on the basis of the radio-wave intensity data.

The connection control unit 33 automatically switches, on the basis of the calculated distance, the wireless connection mode between the detected external device and the computer 10.

Specifically, if the calculated distance is within a predetermined reference distance D, the connection control unit 33 selects an automatic connection mode and automatically establishes wireless connection between the detected external device and the computer 10. Thereby, the computer 10 is enabled to use the detected external device as a peripheral device. As shown in FIG. 2, for example, in the case where the external device (#A) 21 is present within the range of the distance D from the computer 10, the connection control unit 33 automatically executes a process of establishing wireless connection between the external device (#A) 21 and computer 10, when the computer 10 has detected the external device (#A) 21.

In the case where the calculated distance is greater than the predetermined reference distance D, the connection control unit 33 selects not the automatic connection mode, but a manual connection mode. In the manual connection mode, the connection control unit 33 inquires of the user of the computer 10 as to whether wireless connection to the detected external device is to be established or not. If the connection is instructed by the user, the connection control unit 33 establishes the wireless connection to the detected external device.

If the calculated distance is greater than another reference distance which is greater than the reference distance D, the connection control unit 33 stores the identification information, which identifies the detected external device, in a detected-device list, without executing the process of inquiring of the user of the computer 10 as to whether wireless connection to the detected external device is to be established or not. The detected-device list is a list showing all external devices which are already detected. If the user selects one of the external devices shown in the detected-device list, the connection control unit 33 establishes the wireless connection to the selected external device.

As shown in FIG. 2, for example, if the distance between the external device (#A) 21 and computer 10 falls in a range between the distance D and distance E, the connection control unit 33 inquires of the user of computer 10 as to whether wireless connection to the detected external device (#A) 21 is to be established or not, when the computer 10 has detected the external device (#A) 21.

For example, if the distance between the external device (#A) 21 and computer 10 is greater than the distance E, the connection control unit 33 does not inquire of the user as to whether wireless connection to the external device (#A) 21 is to be established or not, when the computer 10 has detected the external device (#A) 21.

As has been described above, the connection control unit 33 automatically establishes wireless connection between the detected external device and the computer 10 only when the distance between the detected external device and the computer 10 is within the reference distance D. Even if an external device, which is present at a far position from the computer 10, is detected, automatic connection to the external device is not executed.

Therefore, it becomes possible to automatically establish wireless connection to an external device which is to be used by the user with high possibility, without causing such a situation that the control of the computer 10 is abruptly shifted to a far distant external device, which is not expected by the user.

The user can individually set the values of the reference distances D and E for each of external devices (or for each of kinds of external devices). In this case, the connection control unit 33 compares the reference distance D, E corresponding to the detected external device and the distance calculated by the distance calculation unit 32, and determines the wireless connection mode, which is to be used, on the basis of the comparison result.

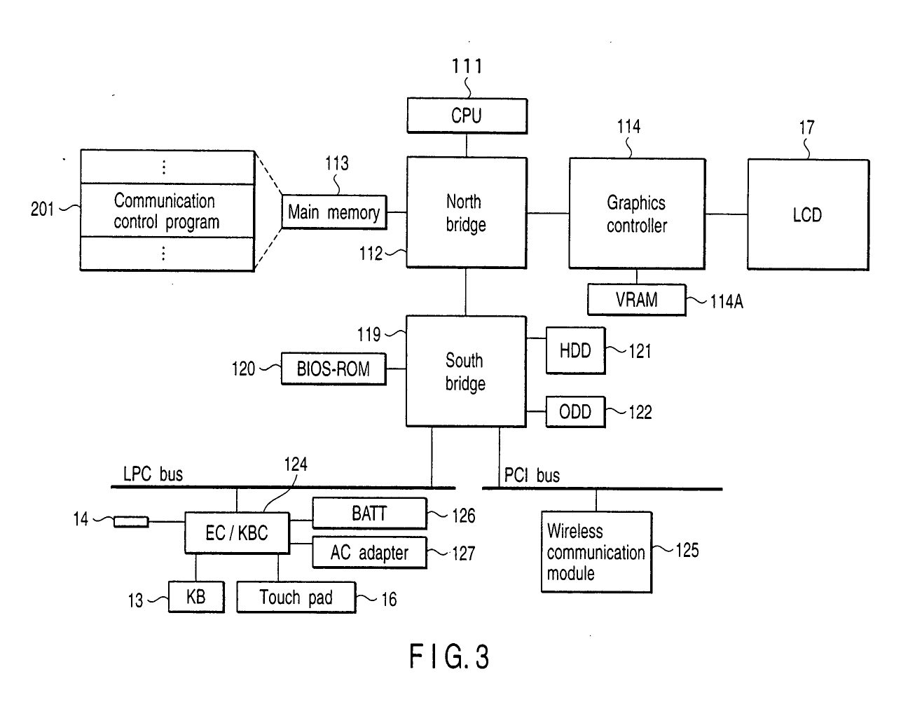

Next, referring to FIG. 3, the system configuration of the computer 10 is described.

The computer 10, as shown in FIG. 3, comprises a CPU 111, a north bridge 112, a main memory 113, a graphics controller 114, a south bridge 119, a BIOS-ROM 120, a hard disk drive (HDD) 121, an optical disc drive (ODD) 122, an embedded controller/keyboard controller IC (EC/KBC) 124, and a wireless communication module 125.

The CPU 111 is a processor that is provided in order to control the operation of the computer 10. The CPU 111 executes an operating system, a communication control program 201 and various application programs, which are loaded from the hard disk drive (HDD) 121 into the main memory 113.

The communication control program 201 is software for controlling the wireless communication module 125. The functions of the above-described device detection unit 31, distance calculation unit 32 and connection control unit 33 are realized by the communication control program 201.

The CPU 111 also executes a BIOS (Basic Input/Output System) that is stored in the BIOS-ROM 120. The system BIOS is a program for hardware control.

The north bridge 112 is a bridge device that connects a local bus of the CPU 111 and the south bridge 119. The north bridge 112 includes a memory controller that access-controls the main memory 113. The north bridge 112 has a function of executing communication with the graphics controller 114 via, e.g. an AGP (Accelerated Graphics Port) bus.

The graphics controller 114 is a display controller for controlling the LCD 17 that is used as a display monitor of the computer 10. The graphics controller 114 causes the LCD 17 to display image data, which is written in a video memory (VRAM) 114A.

The south bridge 119 controls the devices on an LPC (Low Pin Count) bus, and the devices on a PCI (Peripheral Component Interconnect) bus. In addition, the south bridge 119 includes an IDE (Integrated Drive Electronics) controller for controlling the HDD 121 and ODD 122. The south bridge 119 also includes a function for access-controlling the BIOS-ROM 120.

The embedded controller/keyboard controller IC (EC/KBC) 124 is a 1-chip microcomputer in which an embedded controller for power management and a keyboard controller for controlling the keyboard (KB) 13 and touch pad 16 are integrated. The embedded controller/keyboard controller IC (EC/KBC) 124 has a function of powering on/off the computer 10 in response to the user's operation of the power button 14. Operation power, which is supplied to the respective components of the computer 10, is generated from a battery 126 which is built in the computer 10 or from an external power supply which is supplied via an AC adapter 127.

The wireless communication module 125 is a wireless communication unit which executes wireless communication with the external devices 21, 22, 23, . . . . The wireless communication module 125 executes the wireless communication according to a short-distance wireless communication standard such as the Bluetooth™ or Wireless USB.

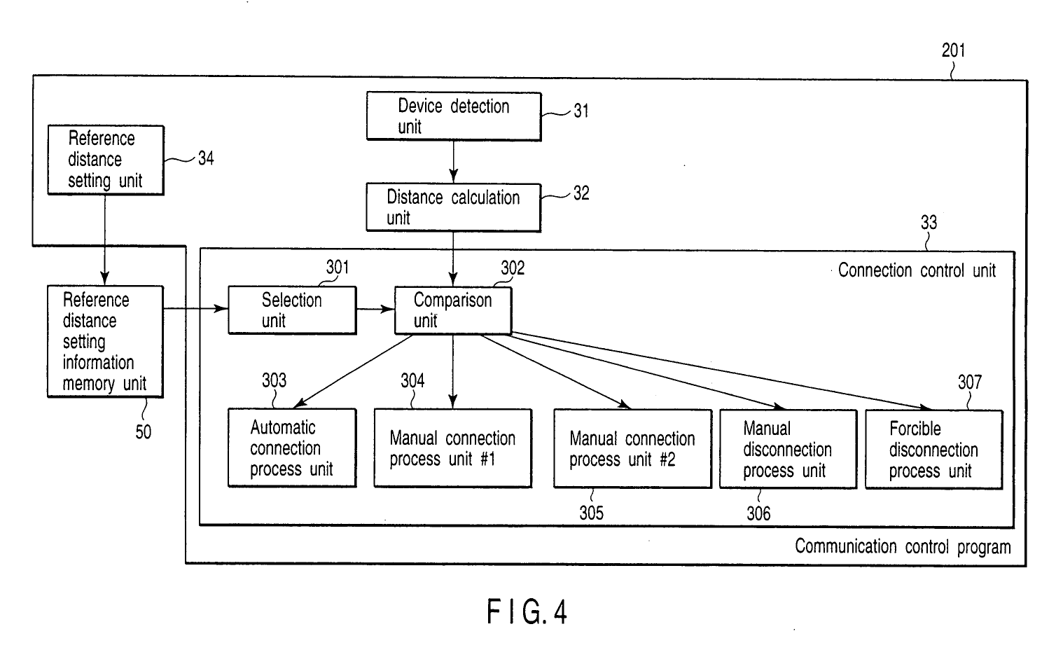

Next, referring to FIG. 4, the functional structure of the communication control program 201 is described.

The communication control program 201 includes, as its function execution modules, the above-described device detection unit 31, distance calculation unit 32 and connection control unit 33.

The connection control unit 33 includes a selection unit 301, a comparison unit 302, and five connection control process units, i.e. an automatic connection process unit 303, a first manual connection process unit 304, a second manual connection process unit 305, a manual disconnection process unit 306 and a forcible disconnection process unit 307.

The selection unit 301 reads out a reference distance corresponding to an external device, which is detected by the device detection unit 31, from a reference distance setting information memory unit 50. The reference distance setting information memory unit 50 stores information indicative of reference distances corresponding to the external devices 21, 22, 23, . . . . Four reference distances D, E, F and G are set as the reference distances corresponding to each of the respective devices. Specifically, reference distance setting information indicative of the four reference distances D, E, F and G for each of the respective devices is stored in the reference distance setting information memory unit 50.

The reference distances D and E are used in order to determine the connection mode to be applied to the detected external device. The reference distances F and G are used in order to determine a disconnection mode to be applied to the external device that is already wirelessly connected to the computer 10. The relationship between the reference distances D, E, F and G is as follows:

D<E<F<G.

For example, in the case where the device detection unit 31 has detected the external device (#A) 21, the selection unit 301 selects the reference distances D and E corresponding to the external device 21 from the reference distances corresponding to the external devices 21, 22, 23, . . . . The distance calculation unit 32 acquires radio-wave intensity data, which corresponds to the external device (#A) 21, from the wireless communication module 125, and calculates the distance between the computer 10 and external device (#A) 21 on the basis of the radio-wave intensity data.

The comparison unit 302 compares the reference distance D, E, which is selected by the selection unit 301, with the distance that is calculated by the distance calculation unit 32. Based on the comparison result, the automatic connection process unit 303, first manual connection process unit 304 or second manual connection process unit 305 is activated.

Specifically, if the calculated distance is within the reference distance D, the automatic connection process unit 303 is activated. The automatic connection process unit 303 controls the wireless communication module 125 and establishes wireless connection to the detected external device (#A) 21. If the calculated distance is greater than the reference distance D and is within the reference distance E, the first manual connection process unit 304 is activated. The first manual connection process unit 304 displays, e.g. a pop-up message, which indicates that the external device (#A) 21 has been detected, on the display screen of the computer 10, and inquires of the user as to whether wireless connection to the detected external device (#A) 21 is to be established or not. If the calculated distance is greater than the reference distance E, the second manual connection process unit 305 is activated. The second manual connection process unit 305 registers the external device (#A) 21 in the detected-device list, without displaying the pop-up message or the like.

The distance calculation unit 32 also calculates the distance between the computer 10 and an external device which is already wirelessly connected to the computer 10. For example, after the wireless connection between the external device (#A) 21 and the computer 10 is established, the distance calculation unit 32 calculates the distance between the external device (#A) 21 and the computer 10, for example, at regular time intervals. The selection unit 301 selects the reference distances F and G corresponding to the external device 21 from the reference distances corresponding to the external devices 21, 22, 23, . . . . The comparison unit 302 compares the reference distance F, G, which is selected by the selection unit 301, with the distance that is calculated by the distance calculation unit 32. Based on the comparison result, the manual disconnection process unit 306 and forcible disconnection process unit 307 are selectively activated.

Specifically, if the distance between the external device (#A) 21 and the computer 10 is the reference distance F or more, the manual disconnection process unit 306 is activated. The manual disconnection process unit 306 displays, e.g. a pop-up message, which indicates that the distance between the external device (#A) 21 and computer 10 has increased, on the display screen of the computer 10, and inquires of the user as to whether the wireless connection between the external device (#A) 21 and computer 10 is to be disconnected or not. In addition, if the distance between the external device (#A) 21 and the computer 10 is the reference distance G or more, the forcible disconnection process unit 307 is activated. The forcible disconnection process unit 307 executes a disconnection process for disconnecting the wireless connection between the external device (#A) 21 and computer 10, without displaying, e.g. a pop-up message, which indicates that the distance between the external device (#A) 21 and computer 10 has increased, on the display screen of the computer 10. In this disconnection process, the wireless connection is broken, for example, after a process for halting the data transfer between the external device (#A) 21 and computer 10 is executed. Thereby, the external device (#A) 21 can safely be disconnected from the computer 10.

In addition, the communication control program 201 includes a reference distance setting unit 34. The reference distance setting unit 34 displays a setup screen for prompting the user to set the values of the reference distances D, E, F and G for each of the external devices, and writes reference distance setting information in the reference distance setting information memory unit 50 in accordance with the operation on the setup screen.

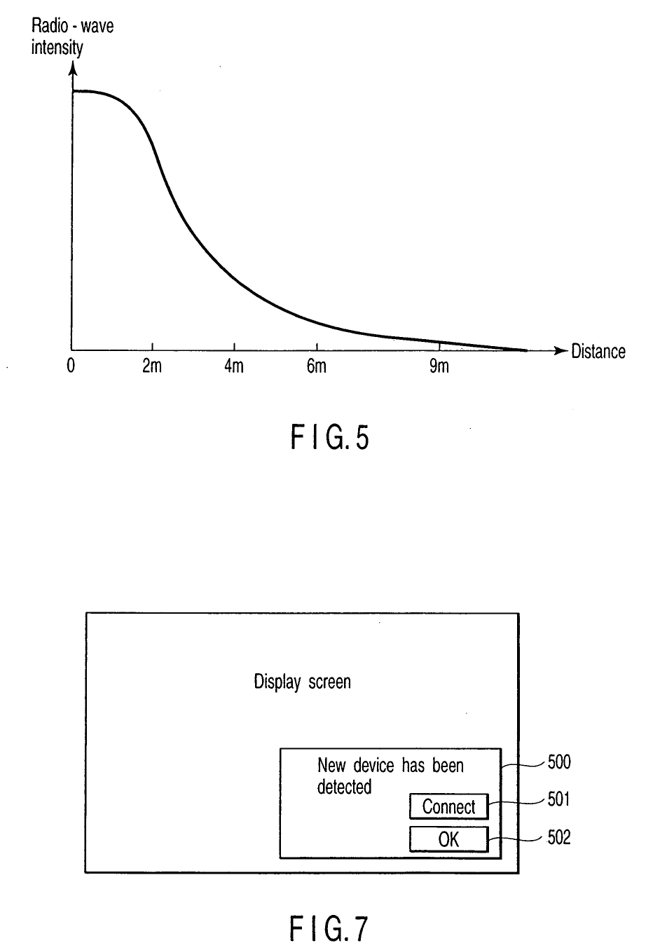

Next, referring to FIG. 5, the relationship between the radio-wave intensity and the distance between the external device and the computer 10 is explained.

FIG. 5 shows an example of attenuation characteristics of radio-wave intensity.

The attenuation characteristics indicate the variation in radio-wave intensity of a wireless signal, which reaches from the external device to the computer 10, relative to the distance between the external device and the computer 10. As is understood from FIG. 5, the attenuation characteristics of radio-wave intensity are expressed approximately by a curve of the second order. The lower the radio-wave intensity, the lower the effective communication speed.

The distance calculation unit 32 executes an arithmetic operation for estimating the distance between the external device and the computer 10 on the basis of the attenuation characteristics shown in FIG. 5 and the radio-wave intensity of the wireless signal which reaches from the external device to the computer 10.

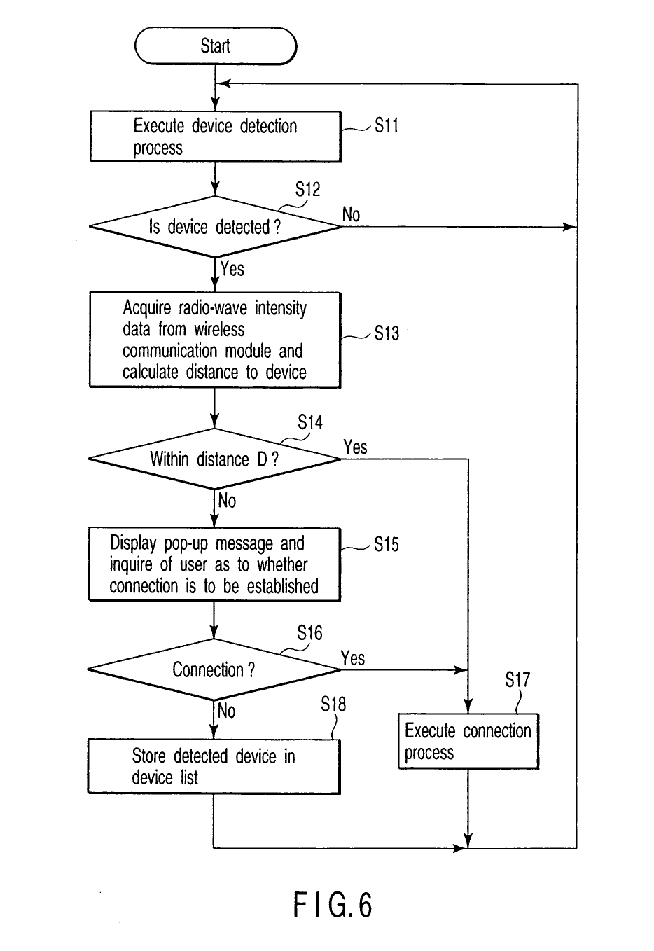

Next, referring to a flow chart of FIG. 6, a description is given of a first example of the procedure of a device connection process which is executed when the device is detected. In this example, the device connection control process is executed by using only the reference distance D of the reference distances D and E.

The communication control program 201 executes a device detection process by using the wireless communication module 125 (block S11). If an external device is detected (YES in block S12), the communication control program 201 acquires radio-wave intensity data of the detected external device from the wireless communication module 125, and calculates the distance between the detected external device and the computer 10 on the basis of the acquired radio-wave intensity data (block S13).

The communication control program 201 compares the reference distance D, which corresponds to the detected external device, with the calculated distance, and determines whether the distance between the detected external device and the computer 10 is within the reference distance D (block S14).

If the distance between the detected external device and the computer 10 is not within the reference distance D (NO in block S14), the communication control program 201 displays a pop-up message which indicates that the external device has been detected, and inquires of the user as to whether wireless connection to the detected external device is to be established or not (block S15). In block S15, a pop-up message 500, as shown in FIG. 7, is displayed on the display screen.

If the user clicks a “CONNECT” button 501 on the pop-up message 500 (YES in block S16), the communication control program 201 executes a connection process for establishing wireless connection between the detected external device and the computer 10 (block S17). In this connection process, a process of starting a program (e.g. device driver) for controlling the detected external device is also executed. Thereby, the detected external device is rendered usable as a peripheral device of the computer 10.

If the user clicks a “OK” button 502 on the pop-up message 500 (NO in block S16), the communication control program 201 stores the identification information of the detected external device in the detected-device list (block S18).

If the distance between the detected external device and the computer 10 is within the reference distance D (YES in block S14), the communication control program 201 executes the connection process for establishing wireless connection between the detected external device and the computer 10 (block S17).

By the above process, it becomes possible to automatically establish connection to an external device which is to be used by the user with high possibility, while preventing an external device, which is located at a relatively distant position from the computer 10 and is not necessary for the user, from being connected to the computer 10.

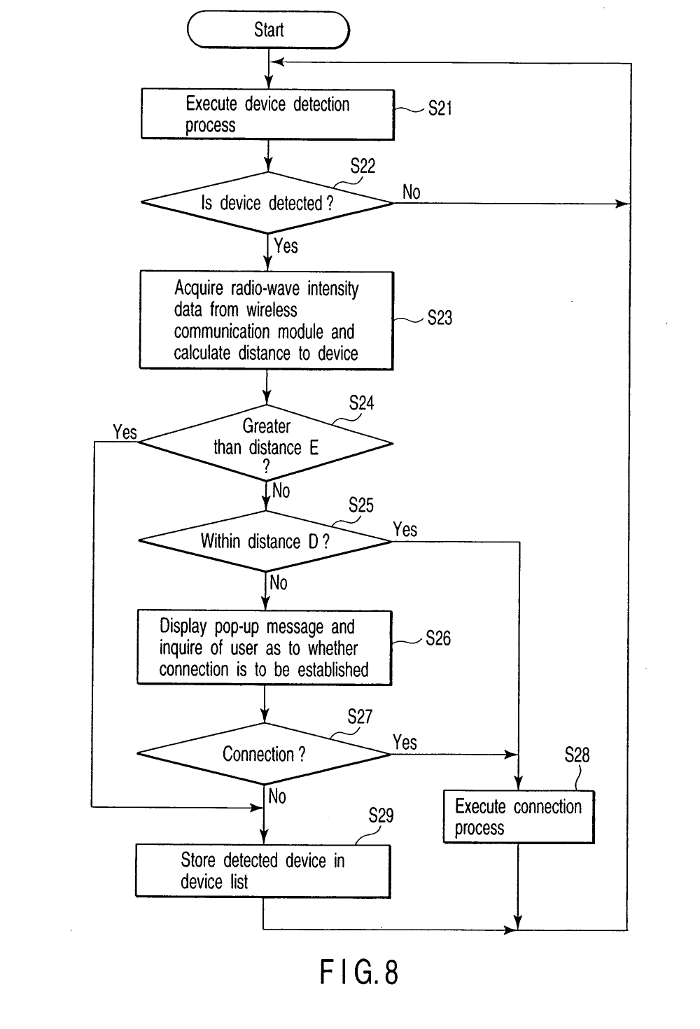

Next, referring to a flow chart of FIG. 8, a description is given of a second example of the procedure of the device connection process which is executed when the device is detected. In this example, the device connection control process is executed by using both the reference distances D and E.

The communication control program 201 executes a device detection process by using the wireless communication module 125 (block S21). If an external device is detected (YES in block S22), the communication control program 201 acquires radio-wave intensity data of the detected external device from the wireless communication module 125, and calculates the distance between the detected external device and the computer 10 on the basis of the acquired radio-wave intensity data (block S23).

The communication control program 201 compares the reference distance E, which corresponds to the detected external device, with the calculated distance, and determines whether the distance between the detected external device and the computer 10 is greater than the reference distance E (block S24).

If the distance between the detected external device and the computer 10 is greater than the reference distance E, the communication control program 201 stores the identification information of the detected external device in the detected-device list (block S29).

If the distance between the detected external device and the computer 10 is within the reference distance E (NO in block S24), the communication control program 201 compares the reference distance D, which corresponds to the detected external device, with the calculated distance, and determines whether the distance between the detected external device and the computer 10 is within the reference distance D (block S25).

If the distance between the detected external device and the computer 10 is within the reference distance D (YES in block S25), the communication control program 201 executes a connection process for establishing wireless connection between the detected external device and the computer 10 (block S28). In this connection process, a process of starting a program (e.g. device driver) for controlling the detected external device is also executed. Thereby, the detected external device is rendered usable as a peripheral device of the computer 10.

If the distance between the detected external device and the computer 10 is not within the reference distance D (NO in block S25), the communication control program 201 displays the pop-up message 500 which indicates that the external device has been detected, and inquires of the user as to whether wireless connection to the detected external device is to be established or not (block S26).

If the user clicks the “CONNECT” button 501 on the pop-up message 500 (YES in block S27), the communication control program 201 executes the connection process for establishing wireless connection between the detected external device and the computer 10 (block S28). If the user clicks the “OK” button 502 on the pop-up message 500 (NO in block S27), the communication control program 201 stores the identification information of the detected external device in the detected-device list (block S29).

By the above process, the display of the pop-up message can be omitted in the case where the distance between the detected external device and the computer 10 is greater than the reference distance E. Therefore, it is possible to prevent the occurrence of an inquiry to the user due to detection of an external device which is to be used by the user with very low possibility.

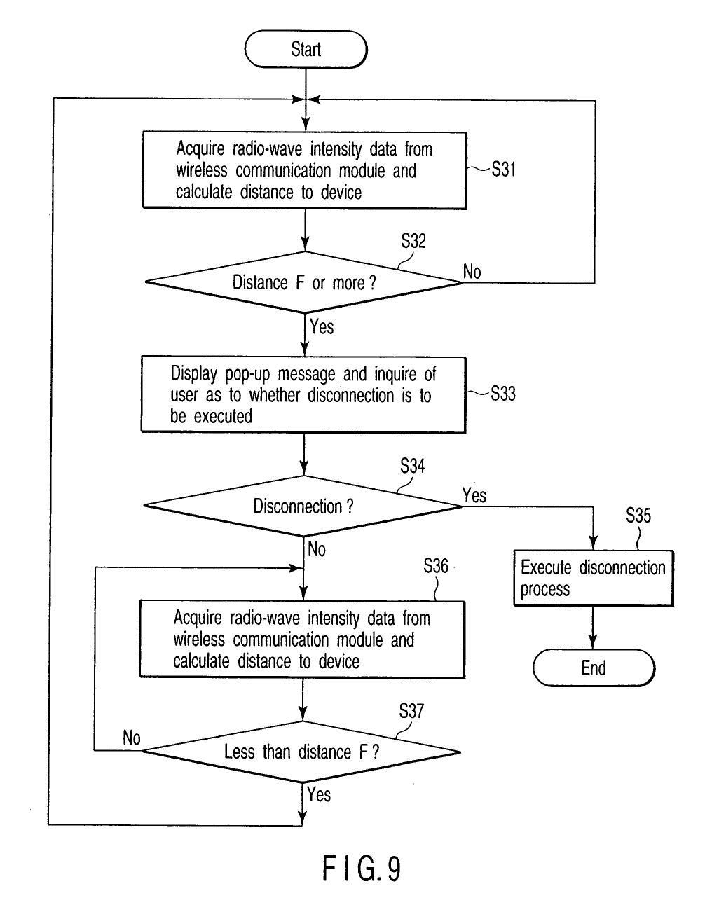

Next, referring to a flow chart of FIG. 9, a description is given of a first example of a device disconnection process which is applied to an external device that is already wirelessly connected to the computer 10. In this example, the device disconnection process is executed by using only the reference distance F of the reference distances F and G.

The communication control program 201 acquires radio-wave intensity data of an external device, which is already wirelessly connected to the computer 10, from the wireless communication module 125, and calculates the distance between the external device and the computer 10 on the basis of the acquired radio-wave intensity data (block S31).

The communication control program 201 compares the reference distance F, which corresponds to the external device, with the calculated distance, and determines whether the distance between the external device and the computer 10 is the reference distance F or more (block S32).

If the distance between the external device and the computer 10 is the reference distance F or more (YES in block S32), the communication control program 201 displays a pop-up message and inquires of the user as to whether the wireless connection to the external device is to be disconnected or not (block S33).

If the disconnection is selected by the user (YES in block S34), the communication control program 201 executes a disconnection process for disconnecting the wireless connection between the external device and the computer 10 (block S35). In the disconnection process, the communication control program 201 disconnects the wireless connection between the external device and the computer 10 after informing the OS that the external device is to be disconnected from the computer 10. Thereby, the external device can safely be disconnected from the computer 10 without causing loss of data which is being transferred, or causing malfunction.

If the disconnection is not selected by the user (NO in block S34), the communication control program 201 waits until the distance between the external device and the computer 10 decreases to less than the reference distance F (block S36, S37). If the distance between the external device and the computer 10 decreases to less than the reference distance F, the communication control program 201 executes the process from block S31 once again.

If the distance between the external device and the computer 10 increases to the reference distance F or more (YES in block S32), the communication control program 201 displays the pop-up message once again and inquires of the user as to whether the wireless connection to the external device is to be disconnected or not (block S33).

By the above process, it is possible to prevent, for example, the external device and the computer 10 from being continuously connected despite the external device being not actually used.

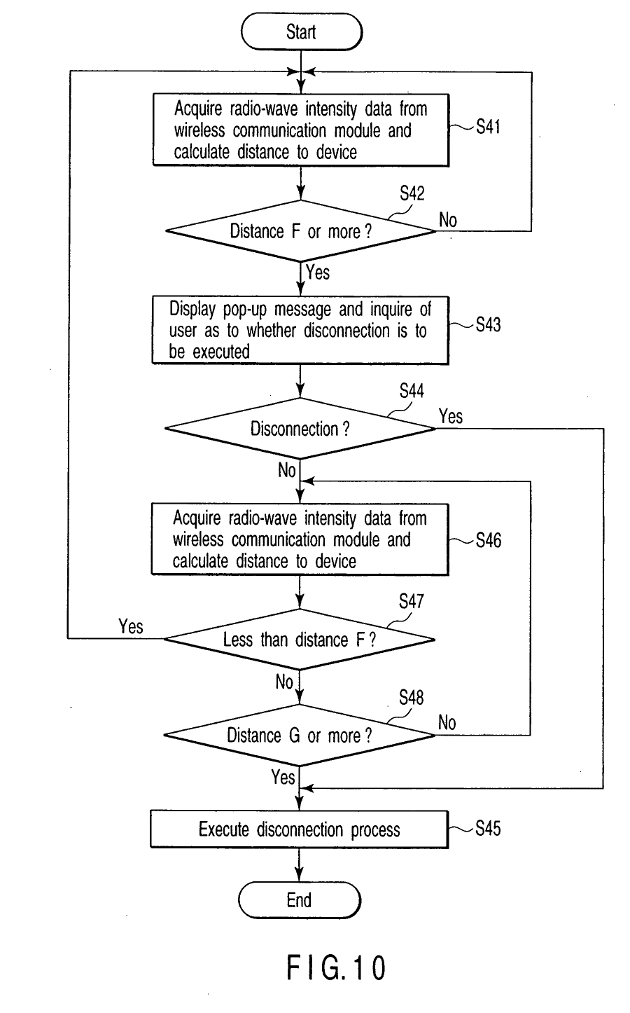

Next, referring to a flow chart of FIG. 10, a description is given of a second example of the device disconnection process which is applied to an external device that is already wirelessly connected to the computer 10. In this example, the device disconnection process is executed by using both the reference distances F and G.

The communication control program 201 acquires radio-wave intensity data of an external device, which is already wirelessly connected to the computer 10, from the wireless communication module 125, and calculates the distance between the external device and the computer 10 on the basis of the acquired radio-wave intensity data (block S41).

The communication control program 201 compares the reference distance F, which corresponds to the external device, with the calculated distance, and determines whether the distance between the external device and the computer 10 is the reference distance F or more (block S42).

If the distance between the external device and the computer 10 is the reference distance F or more (YES in block S42), the communication control program 201 displays a pop-up message and inquires of the user as to whether the wireless connection to the external device is to be disconnected or not (block S43).

If the disconnection is selected by the user (YES in block S44), the communication control program 201 executes a disconnection process for disconnecting the wireless connection between the external device and the computer 10 (block S45). In the disconnection process, the communication control program 201 disconnects the wireless connection between the external device and the computer 10 after informing the OS that the external device is to be disconnected from the computer 10. Thereby, the external device can safely be disconnected from the computer 10 without causing loss of data which is being transferred, or causing malfunction.

If the disconnection is not selected by the user (NO in block S44), the communication control program 201 acquires radio-wave intensity data of the external device from the wireless communication module 125 and calculates once again the distance between the external device and the computer 10 (block S46). The communication control program 201 compares each of the reference distances F and G, which correspond to the external device, with the calculated distance.

If the distance between the external device and the computer 10 decreases to less than the reference distance F (YES in block S47), the communication control program 201 executes the process from block S41 once again.

If the distance between the external device and the computer 10 further increases to the reference distance G or more (YES in block S48), the communication control program 201 executes the disconnection process for disconnecting the wireless connection between the external device and the computer 10 (block S45).

By the above process, the disconnection process can be executed before the distance between the external device and the computer 10 increases and exceeds the communicable distance and the wireless connection between the external device and the computer 10 is abruptly broken.

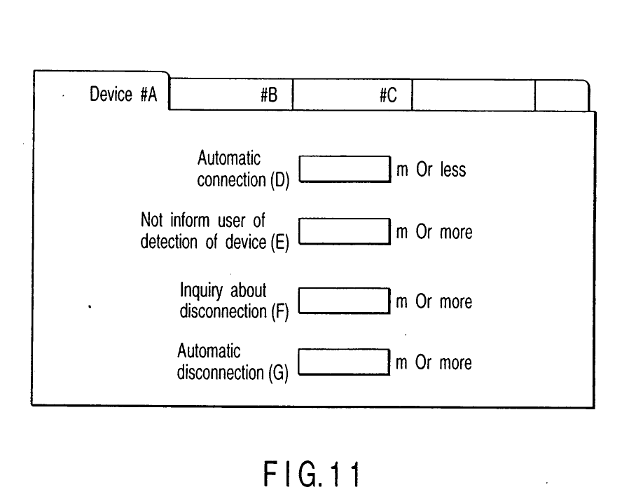

FIG. 11 shows an example of the distance setup screen which is displayed by the communication control program 201. The user can set the values of the above-described reference distances D, E, F and G on this distance setup screen in association with each of external devices or each of the kinds of external devices.

In the above description, the wireless connection between the computer and external device has been described. However, the connection control process according to the present embodiment is applicable to connections between various electronic apparatuses, such as a video recorder and a TV set, and external devices.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus which executes wireless communication, comprising:
a device detection unit which detects an external device which is located within a wireless communication area that is covered by the electronic apparatus;
a distance calculation unit which calculates a distance between the electronic apparatus and the detected external device on the basis of a radio-wave intensity of a wireless signal which is transmitted from the detected external device; and
a connection control unit which establishes wireless connection between the detected external device and the electronic apparatus if the distance calculated by the distance calculation unit is within a predetermined reference distance.

2. The electronic apparatus according to claim 1, wherein the connection control unit inquires of a user as to whether the wireless connection to the detected external device is to be established or not, if the calculated distance is greater than the predetermined reference distance.

3. The electronic apparatus according to claim 1, wherein the distance calculation unit is configured to calculate a distance between an external device, which is already wirelessly connected to the electronic apparatus, and the electronic apparatus, on the basis of a radio-wave intensity of a wireless signal which is transmitted from the external device which is already wirelessly connected to the electronic apparatus, and
the connection control unit inquires of the user as to whether the wireless connection between the external device, which is already wirelessly connected to the electronic apparatus, and the electronic apparatus is to be disconnected or not, if the calculated distance between the external device, which is already wirelessly connected to the electronic apparatus, and the electronic apparatus is another reference distance or more, which is greater than the predetermined reference distance.

4. The electronic apparatus according to claim 3, wherein the connection control unit executes a process for disconnecting the wireless connection between the external device, which is already wirelessly connected to the electronic apparatus, and the electronic apparatus, if the calculated distance between the external device, which is already wirelessly connected to the electronic apparatus, and the electronic apparatus is still another reference distance or more, which is greater than said another reference distance.

5. The electronic apparatus according to claim 1, wherein the detected external device is configured to function as an external input device which inputs information to the electronic apparatus by a wireless signal.

6. The electronic apparatus according to claim 1, wherein the detected external device is configured to function as an external storage device which stores data which is transmitted from the electronic apparatus by a wireless signal.

7. The electronic apparatus according to claim 1, further comprising a memory unit which stores reference distance setting information indicative of a plurality of reference distances corresponding to a plurality of external devices,
wherein the connection control unit selects one of the plurality of reference distances, which corresponds to the detected external device, and establishes wireless connection between the detected external device and the electronic apparatus if the distance calculated by the distance calculation unit is within the selected reference distance.

8. An electronic apparatus comprising:
a wireless communication unit which executes wireless communication
a memory unit which stores reference distance setting information indicative of a plurality of reference distances corresponding to a plurality of external devices which are wirelessly connectable to the electronic apparatus;
a device detection unit which detects an external device which is located within a wireless communication area that is covered by the wireless communication unit;
a distance calculation unit which calculates a distance between the electronic apparatus and the detected external device on the basis of a radio-wave intensity of a wireless signal which is transmitted from the detected external device; and
a connection control unit which selects one of the plurality of reference distances, which corresponds to the detected external device, and establishes wireless connection between the detected external device and the electronic apparatus if the distance calculated by the distance calculation unit is within the selected reference distance.

9. The electronic apparatus according to claim 8, wherein the connection control unit inquires of a user as to whether the wireless connection to the detected external device is to be established or not, if the calculated distance is greater than the selected reference distance.

10. A communication control method for controlling wireless communication which is executed by an electronic apparatus, comprising:
detecting an external device which is located within a wireless communication area that is covered by the electronic apparatus;
calculating a distance between the electronic apparatus and the detected external device on the basis of a radio-wave intensity of a wireless signal which is transmitted from the detected external device; and
executing a connection control process of establishing wireless connection between the detected external device and the electronic apparatus if the calculated distance is within a predetermined reference distance.

11. The communication control method according to claim 10, further comprising inquiring of a user as to whether the wireless connection to the detected external device is to be established or not, if the calculated distance is greater than the predetermined reference distance.

12. The communication control method according to claim 10, further comprising:
calculating a distance between an external device, which is already wirelessly connected to the electronic apparatus, and the electronic apparatus, on the basis of a radio-wave intensity of a wireless signal which is transmitted from the external device which is already wirelessly connected to the electronic apparatus, and
inquiring of the user as to whether the wireless connection between the external device, which is already wirelessly connected to the electronic apparatus, and the electronic apparatus is to be disconnected or not, if the calculated distance between the external device, which is already wirelessly connected to the electronic apparatus, and the electronic apparatus is another reference distance or more, which is greater than the predetermined reference distance.

13. The communication control method according to claim 10, wherein the electronic apparatus includes a memory unit which stores reference distance setting information indicative of a plurality of reference distances corresponding to a plurality of external devices, and
the connection control process includes a process of selecting one of the plurality of reference distances, which corresponds to the detected external device, and a process of establishing wireless connection between the detected external device and the electronic apparatus if the calculated distance is within the selected reference distance.
